(19) United States
(12) Patent Application Publication
(10) Pub. No.: US 2008/0244164 A1
(43) Pub. Date: Oct. 2, 2008

(54) STORAGE DEVICE EQUIPPED WITH NAND FLASH MEMORY AND METHOD FOR STORING INFORMATION THEREOF

(76) Inventors: Yao-Xun Chang, Taipei County (TW); Rong-Hua Kung, Taipei County (TW)

Correspondence Address: Joe McKinney Muncy, PO Box 1364, Fairfax, VA, 22038-1364, US

(21) Appl. No.: 12/027,055

(22) Filed: Feb. 6, 2008

(30) Foreign Application Priority Data
Apr. 2, 2007 (TW) 096111527

(51) Int. Cl. G06F 12/00

(52) U.S. Cl. 711/103; 711/E12.001

(57) ABSTRACT

A storage device equipped with NAND flash memory and method for storing information thereof includes a SLC processing structure to provide fast information access and improve processing performance and a MLC processing structure to increase data density of each storage unit and reduce the cost and size of each unit of information. The data storing method includes storing important information such as operating system programs, application programs and information that have been accessed frequently in the SLC processing structure, and storing ordinary information in the MLC processing structure to reduce the cost and size of each unit of information.

### FIELD OF THE INVENTION

The present invention relates to a storage device equipped with NAND flash memory and method for storing information thereof particularly to device to store electronic information through a single-level-cell (SLC) processing structure and a multi-level cell (MLC) processing structure.

### BACKGROUND OF THE INVENTION

Flash memory is widely used on electronic devices such as handsets and digital cameras. The conventional flash memory mostly is used as a portable information storage device or memory card. The flash memory usually is coupled with an interface conforming to USB or other memory card specifications. The present flash memory mainly includes two types, i.e. NOR logic (based on Not-OR) and NAND logic (based on Not-AND). The NOR logic flash memory has a parallel structure to accelerate data reading and bit rewriting. The NAND logic flash memory has a memory cell to provide faster writing/erasing. It also consumes less electric power for data writing and has a higher density for memory cell array, thus provides a higher capacity for each unit size (square mm-sqmm) of chip.

In terms of processing structure, the flash memory can adopt SLC (Single-Level-Cell), MLC (Multi-Level-Cell) or MBC (Multi-Bit-Cell). In terms of usage of the memory cell the SLC flash memory is the same as an EEPROM (Electronically Erasable Programmable Read-Only Memory), but has a thinner oxidate film on the floating gate and source of the transistor. Data writing is done by applying a voltage through electric charges of the floating gate. The stored electric charges can be erased through the source. Such an approach can store an information bit (1 for deleting, and 0 for writing). This technique allows one cell to provide fast program editing and access. However, this technique is constrained by a lower silicon efficiency. Only through advanced process enhancements can the application scope of the SLC device be expanded.

The MLC flash memory has different levels of electric charges on the floating gate, and can store two bits of information in one transistor. By controlling writing and sensing of memory cell, one transistor can generate four levels of cell. This approach provides a medium speed for data reading and writing, and requires an optimum sensing circuitry.

The MBC flash memory has electric charges (namely data bits) stored respectively at two different ends of a transistor. The stored data can be read, written and erased individually. It stores two bits in one cell, and provides a structure at a lower cost, faster read/write speed and higher data storage density for each cell.

In recent years, the technology of flash memory is well developed and the price has dropped to an acceptable level on the market, many storage device producers are considering to substitute a portion or all of the traditional hard disk with the flash memory. For instance, a hybrid hared disk drive is one that combines the flash memory and the traditional hard disk with the flash memory functioned as a large cache of the traditional hard disk. However, the hybrid hared disk drive still uses the traditional hard disk as the main storage device, and cannot fully take the advantages of the flash memory such as fast read/write speed, less power consumption during data writing, and more reliable reading and writing operation under impact.

Some producers choose the SLC or MLC flash memory to fully replace the traditional hard disk storage device. It is also called a solid state hard disk. The solid state hard disk adopted the SLC flash memory can provide the benefits of fast read/write speed, less power consumption during data writing, and more reliable reading and writing operation under impact, the data density of each storage unit is still lower than the traditional hard disk. Hence for a given capacity the solid state hard disk made from the SLC flash memory still has drawbacks of a larger size and higher cost. The solid state hard disk adopted the MLC flash memory can overcome the problems of bulky size and higher cost, but its read/write speed is slower.

U.S. Pat. No. 5,671,388 submitted on May 3, 1995 entitled “METHOD AND APPARATUS FOR PERFORMING WRITE OPERATIONS IN MULTI-LEVEL CELL STORAGE DEVICE” discloses a hybrid storage device including a SLC or MLC memory. It offers the benefits of SLC and MLC flash memory. However, its storage structure has the memory limited to a flash EEPROM of the SLC or MLC flash memory, and cannot adopt the SLC or MLC type NAND logic memory cell. It is against the main stream of the present storage device. There is still room for improvement.

### SUMMARY OF THE INVENTION

The primary object of the present invention is to provide a storage device equipped with NAND flash memory that has a SLC processing structure to provide faster information access speed to enhance processing performance and a MLC processing structure to increase data density of each storage unit to reduce the cost and size of each unit of information thereby to reach a balance of the cost, size and access speed of the storage device.

To achieve the foregoing object the storage device equipped with NAND flash memory of the invention includes a SLC processing structure to store one bit of information by applying a voltage on electric charges of a floating gate of a first transistor which also has a first source to erase the one bit information by removing the stored electric charges, and a MLC processing structure to store two bits of information by applying a voltage on a plurality of electric charges of differential potentials on a floating gate of a second transistor which also has a second source to erase the two bits of information by removing the stored electric charges.

Another object of the invention is to provide a method for storing information to store important information such as operating system programs and application programs or frequently accessed information in the SLC processing structure to improve access speed and processing performance, and store ordinary information in the MLC processing structure to reduce the cost and size of each unit of information.

In one aspect the method for storing information according to the invention is adopted on a storage device equipped with NAND logic flash memory. The storage device includes a SLC processing structure to store one bit of information and a MLC processing structure to store two bits of information. The method includes: getting an information; setting a priority sequence of the information according to a priority authorization; determining the sequence of storing the information in the SLC processing structure or the MLC processing structure according to the priority sequence; and getting a remained storage space condition of the SLC processing structure and MLC processing structure, and determining whether to store the information in either the SLC processing structure or the MLC processing structure according to the priority sequence of the information.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a structural block diagram of a first embodiment of the invention.

FIG. 2 is a structural block diagram of a second embodiment of the invention.

FIG. 3 is flowchart-1 of a third embodiment of the invention.

FIG. 4 is flowchart-2 of the third embodiment of the invention.

FIG. 5 is flowchart-3 of the third embodiment of the invention.

### DETAILED DESCRIPTION OF THE PREFERRED EMBODIMENTS

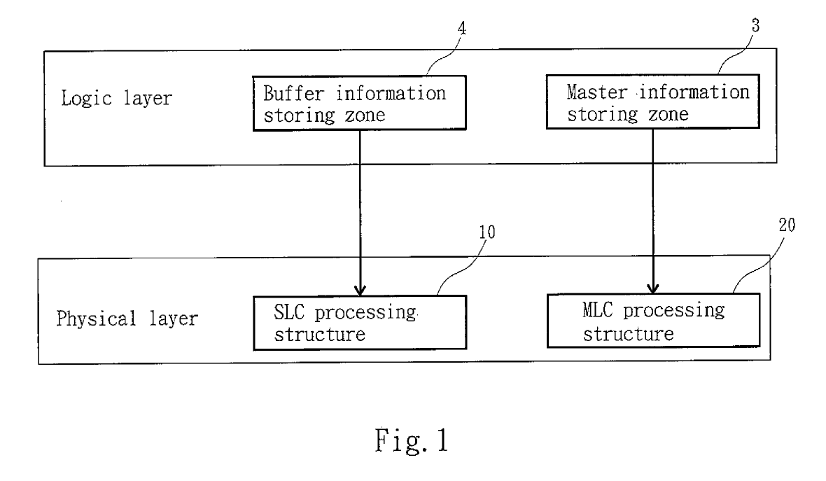

Please refer to FIG. 1 for the structure of a first embodiment of the invention. The storage device equipped with NAND flash memory of the invention includes:

a SLC processing structure 10 to store one bit of information by applying a voltage on electric charges of a floating gate of a first transistor (not shown in the drawing) which has a first source to remove the electric charges to erase the one bit information; and

a MLC processing structure 20 to store two bits of information by applying a voltage on a plurality of electric charges of differential potentials on a floating gate of a second transistor which has a second source to erase the two bits of information by removing the stored electric charges. The physical and circuit structures of NAND logic flash memory, SLC processing structure 10 and MLC processing structure 20 are known in the art and form no part of the invention, thus details are omitted.

By means of the construction set forth above, the SLC processing structure 10 provides faster information access and can improve processing performance, while the MLC processing structure 20 can increase density of the storing data to reduce the cost and size of each unit of information to reach total balance of the cost, size and access speed of the storage device.

The MLC processing structure 20 has a second logic layer with a master information storing zone 3 formed thereon to substitute the disk of a conventional hard disk. The SLC processing structure 10 has a first logic layer with a buffer information storing zone 4 formed thereon. The buffer information storing zone 4 aims to substitute the buffer storage device such as a cache memory of the conventional hard disk. Operation method is as follow: during reading data user's operating system first searches the buffer information storing zone 4; if none is found the master information storing zone 3 is read. During writing data user's operating system gives a higher priority to write on the buffer information storing zone 4. Because writing speed to the buffer information storing zone 4 is faster, the operating system at the user end can rapidly finish the writing operation and process other tasks until the storage space in the buffer information storing zone 4 is not adequate, then the data stored in the buffer information storing zone 4 is updated to the master information storing zone 3, and the storage space of the buffer information storing zone 4 is released to be used later on by the user's operating system. Releasing of the data from the buffer information storing zone 4 may be performed according to the priority of use frequency of the data. Another approach is to update the data by a firmware in a background fashion to the master information storing zone 3 after the data in the buffer information storing zone 4 has been idled without being accessed for a period of time.

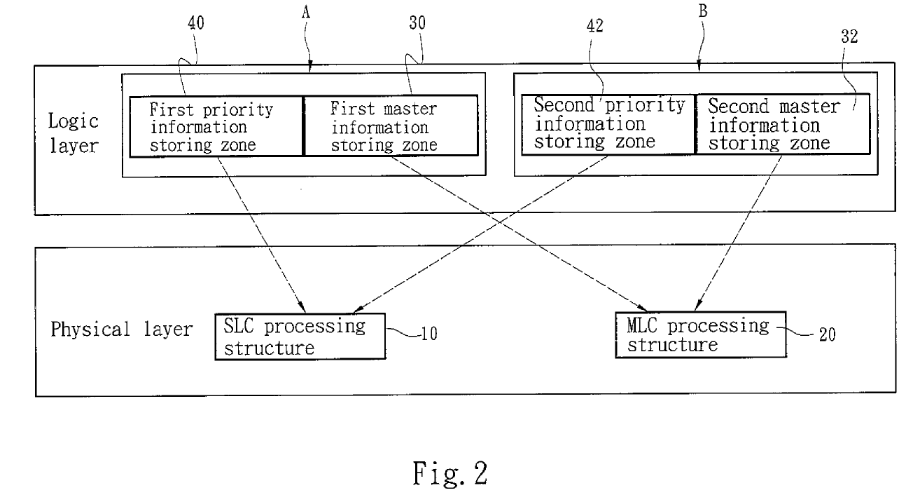

Refer to FIG. 2 for the structure of a second embodiment of the invention. It differs from the first embodiment previously discussed by having a first master information storing zone 30 and a second master information storing zone 32 on the second logic layer of the MLC processing structure 20. The SLC processing structure 10 has a first priority information storing zone 40 and a second priority information storing zone 42 on the first logic layer thereof. The first master information storing zone 30 and the first priority information storing zone 40 are being defined as a first disk A, while the second master information storing zone 32 and the second priority information storing zone 42 are being defined as a second disk B.

Moreover, the storage device may be coupled with an information storage system (not shown in the drawings) which sets priority for different types of information definitions according to priority authority. Based on the priority information is stored in either the SLC processing structure 10 or the MLC processing structure 20. For instance, the information storage system sets important information such as the operating system programs and application programs at a higher priority to be stored in the SLC processing structure 10. Information originally stored in the MLC processing structure 20 and accessed more frequently can also be set at a higher priority so that they are stored in the SLC processing structure 10 and transferred afterwards to the MLC processing structure 20.

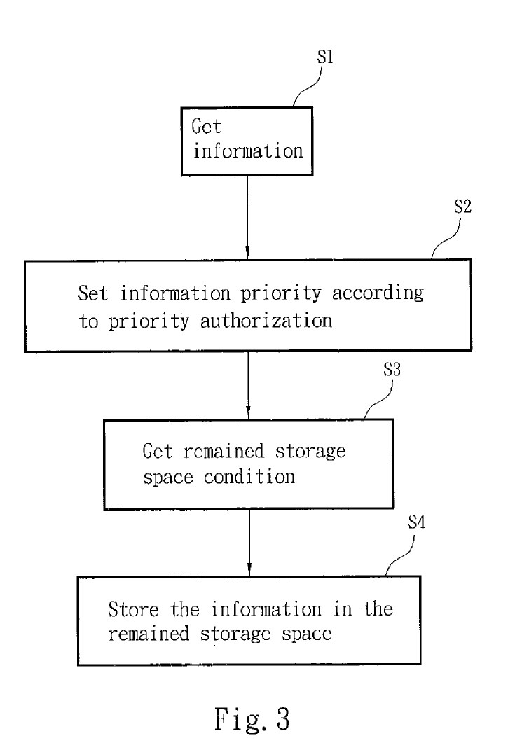

Refer to FIG. 3 for flowchart-1 of a third embodiment of the invention that is an information storing method adopted for use on the storage device equipped with NAND logic flash memory previously discussed. The method includes the steps of:

getting an information (S1);

setting a priority of the information according to a priority authorization (S2);

determining a sequence for storing the information in the SLC processing structure 10 or the MLC processing structure 20 according to the priority; and

getting a remained storage space condition of the SLC processing structure 10 and the MLC processing structure 20 (S3), and determining whether to store the information to either the SLC processing structure 10 or the MLC processing structure 20 according to the priority of the information (S4).

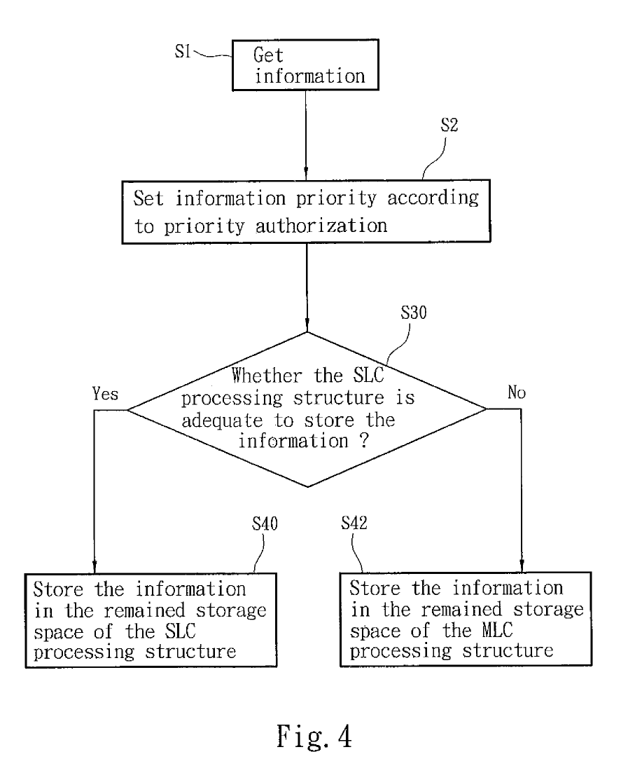

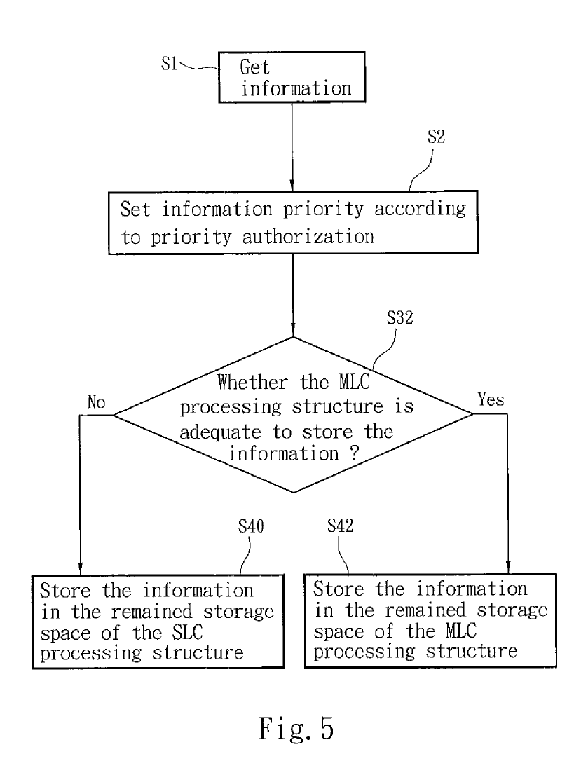

For instance, in the event that the priority authorization setting sets a higher priority for the SLC processing structure 10 to store information of a higher priority (such as operating system programs, application programs or data being accessed more frequently) in the remained storage space of the SLC processing structure 10, and a lower priority for the MLC processing structure 20 to store other information of a lower priority (such as ordinary information) in the remained storage space of the MLC processing structure 20; referring to FIG. 4, after the higher priority information has gone through the steps S1 and S2, whether the remained storage space in the SLC processing structure 10 is adequate to store the higher priority information is determined at step S30; if the outcome is positive the information is stored in the SLC processing structure 10 (840); otherwise the information is stored in the remained storage space of the MLC processing structure 20 (S42). FIG. 5 illustrates that after the information of a lower priority has gone through steps S1 and S2, whether the remained storage space in the MLC processing structure 20 is adequate to store the lower priority information is determined at step S32; if the outcome is positive, the information is stored in the MLC processing structure 20 (S42); otherwise the information is stored in the remained storage space of the SLC processing structure 10 (840).

Therefore, through the information storing method of the invention important information such as operating system programs, application programs or information that is accessed more frequently can be stored in the SLC processing structure 10 to improve access speed and processing performance, and the ordinary information can be stored in the MLC processing structure 20 to reduce the cost and size of the storage device for each unit of information.

As a conclusion, the storage device equipped with NAND flash memory according to the invention can improve information access speed and processing performance through the SLC processing structure 10 and increase data density of each unit of stored information and reduce the cost and size of the storage device for each unit of information. As a result total balance of the storage device in terms of cost, size and access speed can be achieved. In addition, important information such as operating system programs, application programs, and information that is accessed more frequently can be stored in the SLC processing structure 10 to improve the access speed and processing performance, and the ordinary information can be stored in the MLC processing structure 20 to reduce the cost and size of the storage device for each unit of information. It offers a significant improvement over the conventional storage devices.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A storage device equipped with NAND flash memory, comprising:
a single-level-cell (SLC) processing structure to store one bit of information by applying a voltage on first electric charges of a first floating gate of a first transistor which has a first source to remove the first electric charges to erase the one bit information; and
a multi-level-cell (MLC) processing structure to store two bits of information by applying a voltage on a plurality of second electric charges of differential potentials on a second floating gate of a second transistor which has a second source to erase the two bits of information by removing the stored second electric charges.

2. The storage device of claim 1, wherein the MLC processing structure serves as a master information storing zone and the SLC processing structure serves as a buffer information storing zone.

3. The storage device of claim 2, wherein the buffer information storing zone provides a higher priority access of information until storage space of the buffer information storing zone is inadequate then the information stored in the buffer information storing zone is updated in the master information storing zone and finally the storage space in the buffer information storing zone is released.

4. The storage device of claim 3, wherein the storage space of the buffer information storing zone is released according to a priority based on use frequency of the information.

5. The storage device of claim 3, wherein the storage space of the buffer information storing zone is released according to an idle period of the information stored in the buffer information storing zone without being accessed so that the information is updated to the master information storing zone.

6. The storage device of claim 1, wherein the MLC processing structure has a first master information storing zone and a second master information storing zone, and the SLC processing structure has a first priority information storing zone and a second priority information storing zones the first master information storing zone and the first priority information storing zone being defined as a first disk, the second master information storing zone and the second priority information storing zone being defined as a second disk

7. The storage device of claim 1, 2, 3, 4, 5 or 6, wherein the storage device is coupled with an information storage system which sets a priority for different types of information according to a priority authorization, the priority determining whether the information to be stored either in the SLC processing structure or the MLC processing structure.

8. The storage device of claim 7, wherein the information storage system sets operating system programs and application programs at a higher priority to be stored in the SLC processing structure.

9. The storage device of claim 7, wherein the information storage system sets information originally stored in the MLC processing structure that has been accessed frequently at a higher priority to be stored in the SLC processing structure.

10. The storage device of claim 7, wherein the information storage system transfers and stores information originally stored in the MLC processing structure that has been accessed frequently in the SLC processing structure.

11. A method for storing information used on a storage device equipped with NAND flash memory, the storage device having a single-level-cell (SLC) processing structure to store one bit of information and a multi-level-cell (MLC) processing structure to store two bits of information, the method comprising the steps of:
getting an information;
setting a priority of the information according to a priority authorization;
determining a sequence for storing the information in the SLC processing structure or the MLC processing structure (20) according to the priority; and
getting a remained storage space condition of the SLC processing structure and the MLC processing structure, and determining whether to store the information to either the SLC processing structure or the MLC processing structure according to the priority of the information.

12. The method of claim 11, wherein the step of setting a priority of the information according to a priority authorization sets a high priority on the SLC processing structure to store the information of a higher priority in the remained storage space of the SLC processing structure.

13. The method of claim 11, wherein the step of setting a priority of the information according to a priority authorization sets a low priority on the MLC processing structure to store the information of a lower priority at a higher priority in the remained storage space of the MLC processing structure.
